(19) United States
(12) Patent Application Publication
(10) Pub. No.: US 2024/0286053 A1
(43) Pub. Date: Aug. 29, 2024

(54) INTERCOMMUNICATIVE HOLOGRAPHIC BLADE ASSEMBLY IN A PLUSH LIKE TOY

(71) Applicant: Sergei C. Baranoff, West Sacramento, CA (US)

(72) Inventor: Sergei C. Baranoff, West Sacramento, CA (US)

(21) Appl. No.: 18/590,287

(22) Filed: Feb. 28, 2024

Related U.S. Application Data
(60) Provisional application No. 63/448,775, filed on Feb. 28, 2023.

(51) Int. Cl. A63H 3/00; A63H 3/02; G03H 1/02

(52) U.S. Cl. CPC A63H 3/006; A63H 3/02; G03H 1/02; A63H 2200/00; G03H 2001/0212; G03H 2001/0216; G03H 2210/62; G03H 2222/12; G03H 2222/34; G03H 2226/04; G03H 2227/06

(57) ABSTRACT

A toy includes a plush body integrated with a fan blade LED assembly. The fan blade LED assembly includes one or more fan blades, a motor to drive the blades, an array of programmable LED lights, and a controller configured to control the operation of the motor and LED lights. By controlling these components, the toy can generate images through specific sequences of lighting while the fan blades rotate. The fan blade assembly is encased within a translucent shell embedded in the plush body, enhancing the visual effects of the images created.

### CROSS REFERENCE TO RELATED APPLICATION

This application claims the benefit of U.S. Provisional Application No. 63/448,775, titled “Intercommunicative Holographic Blade Assembly In A Plush Like Toy,” filed Feb. 28, 2023, which is incorporated by reference in its entirety.

### BACKGROUND

A plush toy, often referred to as a stuffed toy, is a soft, padded toy made from cloth and filled with materials such as cotton, wool, or synthetic fibers. These toys come in various shapes and sizes, often resembling animals, cartoon characters, or other whimsical creatures. Their soft and cuddly exterior makes them particularly appealing to hold and snuggle with. Plush toys can provide children with a sense of comfort and security. They also serve as a stimulus for imaginative play, becoming a familiar and comforting presence in a child's life. They can act as a constant companion through various stages of childhood, providing a sense of continuity and stability.

However, conventional plush toys do not offer interactivity. While they can be cuddled, dressed, or incorporated into imaginative play, they are static and lack interactive features like sounds, lights, and movement. As such, plush toys, while tactile, generally lack the visual and auditory stimuli that are important for developing specific sensory skills in children.

### SUMMARY

Embodiments described herein solve the above-described problem by integrating a fan blade LED assembly into a plush toy. In accordance with some embodiments, a toy includes a plush body, a fan blade LED assembly embedded in the plush body, and an encasing shell configured to encase the fan blade LED assembly. The fan blade LED assembly includes one or more fan blades, and an array of LED lights on each of the one or more fan blades, a motor coupled to the one or more fan blades to cause the one or more fan blades to rotate. The fan blade LED assembly also includes a controller configured to control the motor and the array of programmable LED lights to cause the array of the programmable LED lights to switch on or off in specific sequences while the one or more fan blades are rotating, creating one or more images. In some embodiments, the one or more images are configured to form one or more animations.

The encasing shell is configured to encase the fan blade LED assembly. In some embodiments, at least a portion of the encasing shell includes a translucent material, through which the one or more images are projected. In some embodiments, the translucent material includes at least one of the following materials: frosted glass, frosted plastic, and/or frosted crystal. In some embodiments, the encasing shell is in one of the following shapes: a spherical shape, a semi-spherical shape, a dome-like shape, an elliptical shape, a semi-elliptical shape, or an elliptical dome-like shape.

In some embodiments, the toy further includes an intercommunication module embedded in the plush body. The intercommunication module is configured to communicate with an external device. The fan blade LED assembly is configured to display one or more images based on communication with the external device.

In some embodiments, the toy is a first toy, and the external device is a second toy. The first toy and the second toy are configured to communicate with each other. Controllers of the first toy and the second toy are configured to synchronize to cause fan blade LED assemblies of the first toy and the second toy to display correlated images based on communication between the first toy and the second toy.

In some embodiments, the toy is a first toy, and the first toy is configured to form an ad hoc network with a plurality of second toys. The ad hoc network facilitates communication among the first toy and the plurality of second toys, causing the first toy and the plurality of second toys to synchronize and display one or more correlated images based on the communication.

In some embodiments, the intercommunication module is configured to determine whether a second toy is nearby or within a predetermined distance, and responsive to determining that the second toy is nearby or within the predetermined distance, the controller causes the fan blade LED assembly to display one or more predetermined animations.

In some embodiments, the intercommunication module includes at least one of: a Wi-Fi module configured to communicate with external devices via a wireless internet network, a Bluetooth module configured to communicate with external devices over a short-range wireless network, a near field communication (NFC) module configured to communicate with external devices over a close-range wireless network, or a cellular radio module configured to communicate with external devices over a cellular network.

### BRIEF DESCRIPTION OF THE DRAWINGS

FIG. 1 illustrates an example plush toy with a fan blade LED assembly embedded therein in accordance with one or more embodiments.

FIG. 2 illustrates an example fan blade with an array of programmable LED lights embedded thereon in accordance with one or more embodiments.

FIG. 3A is a top view of the fan blade LED assembly in accordance with one or more embodiments.

FIG. 3B is a side view of the fan blade LED assembly in accordance with one or more embodiments.

FIG. 4 illustrates an example environment in which two fan blade LED assemblies are configured to communicate with each other in accordance with one or more embodiments.

FIG. 5A illustrates an example environment in which two toys are configured to communicate with each other in accordance with one or more embodiments.

FIG. 5B illustrates an example environment in which multiple toys are configured to communicate with each other via peer-to-peer communication in accordance with one or more embodiments.

FIG. 5C illustrates an example environment in which multiple toys are configured to communicate with each other via a network in accordance with one or more embodiments.

### DETAILED DESCRIPTION

Conventional plush toys generally do not offer interactivity. While they can be cuddled, dressed, or incorporated into imaginative play, they are static and lack interactive features like sounds, lights, and movement. As such, plush toys, while tactile, generally lack the visual and auditory stimuli that are important for developing specific sensory skills in children.

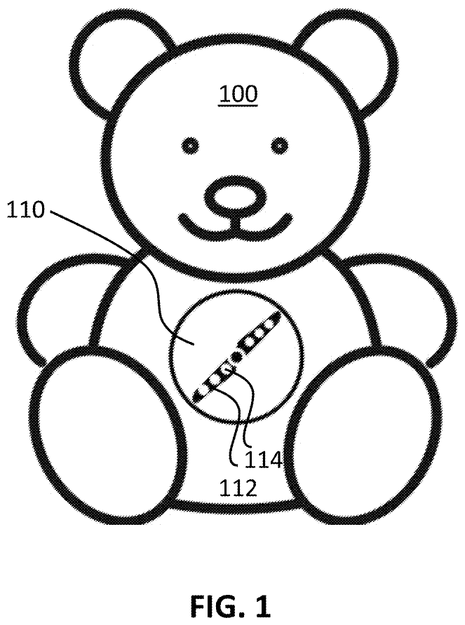

Embodiments described herein solve the above-described problem by integrating a fan blade LED assembly into a plush toy. FIG. 1 illustrates an example plush toy 100 with a fan blade LED assembly 110 embedded therein in accordance with one or more embodiments. As illustrated, the toy 100 includes a plush body, a fan blade LED assembly 110 embedded in the plush body, and an encasing shell configured to encase the fan blade LED assembly. The plush body may be in a shape of an animal (e.g., a bear), a character, a household time, or a general shape.

The fan blade LED assembly 110 is embedded in the plush body. The fan blade LED assembly 110 includes one or more fan blades 112, an array of LED lights 114 on each of the one or more fan blades 112, and a motor coupled to the one or more fan blades 112 to cause the one or more fan blades 112 to rotate. The fan blade LED assembly 110 also includes a controller configured to control the motor and the array of programmable LED lights 114 to cause the array of the programmable LED lights 114 to switch on or off in specific sequences while the one or more fan blades 112 are rotating, creating one or more images. In some embodiments, the one or more images are configured to form one or more animations. When the fan blades 112 rotate, the LED lights 114 on the fan blades 112 light up according to a programmed sequence. Because the fan blade 112 rotates rapidly, the users (or human eyes) cannot see the individual fan blade 112 moving. Instead, users see a continuous image. This is a phenomenon where an afterimage remains on a retina of a user for a brief time after the image source has been removed from view. By rapidly blinking the LED lights 114 on and off as the fan blade 112 rotates, the fan blade LED assembly 110 creates an illusion of a full, continuous image floating in the air. In some embodiments, the fast rotation of the fan blades 112 and programming of the LED lights 114 can create visuals that appear three-dimensional from certain perspectives. This effect, combined with the absence of a visible screen or surface, creates an illusion of a hologram or a holographic animation.

In some embodiments, the toy 100 may also include a speaker configured to make sound accompanying the images or animations. In some embodiments, the toy 100 may also include robotic components configured to move automatically. The movement may also accompany images, animations, and/or sound.

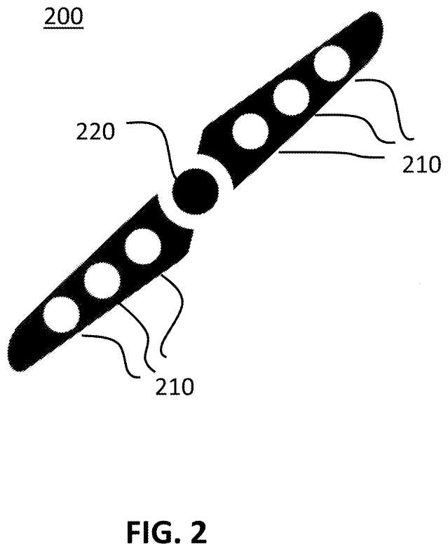

FIG. 2 illustrates an example fan blade 200 with an array of programmable LED lights 210 embedded thereon in accordance with one or more embodiments. The fan blade 200 is symmetric about a hub 220 and configured to rotate about the hub 220. On each side of the fan blade 200, a plurality of LED lights 210 are embedded thereon. The fan blade may be in various shapes to increase or reduce airflow, to increase or reduce noise, or for specific aesthetic purposes.

In some embodiments, the fan blade 200 is a straight blade, extending straight out from a hub. In some embodiments, the fan blade 200 is a curved blade that curves either forward or backward to reduce noise. In some embodiments, the fan blade 200 is a sickle-shaped blade having a curve that resembles a sickle. In some embodiments, the fan blade 200 is an airfoil-shaped blade. In some embodiments, the fan blade 200 is a swept blade that is swept back or forward in relation to a direction of rotation. In some embodiments, the fan blade 200 is a broad paddle blade that is wide and flat. In some embodiments, the fan blade 200 is a narrow blade. Depending on the shape of the fan blade 200, there may be more or fewer programmable LED lights embedded thereon. For example, for a broad paddle blade, there may be a matrix of programmable LED lights 210 embedded thereon. For a narrow blade, there may be a line of programmable LED lights 210 embedded thereon, as illustrated in FIG. 1.

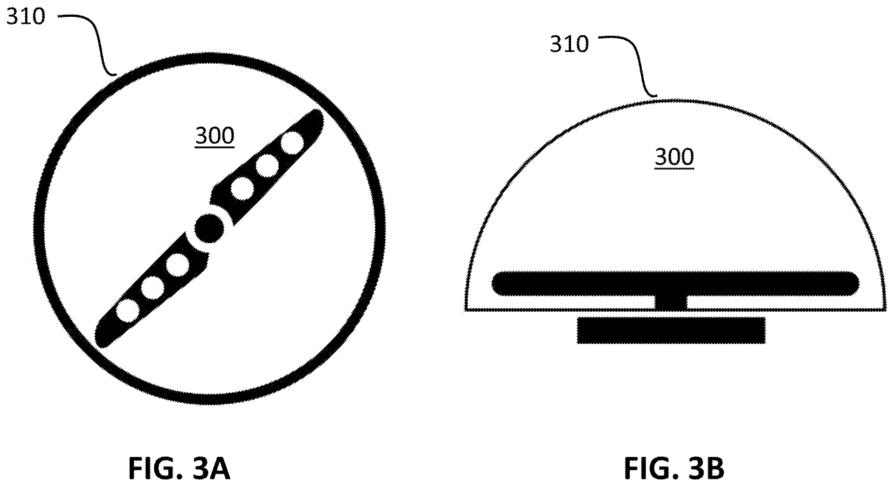

FIGS. 3A and 3B illustrate an example fan blade LED assembly 300 encased in an encasing shell 310 in accordance with one or more embodiments. At least a portion of the encasing shell 310 is transparent or translucent, through which the one or more images are projected. FIG. 3A is a top view of the fan blade LED assembly 300. FIG. 3B is a side view of the fan blade LED assembly 300.

As illustrated in FIGS. 3A and 3B, the encasing shell 310 is in a semi-spherical shape. In some embodiments, the encasing shell may be in a different shape, such as (but not limited to) a spherical shape, a dome-like shape, an elliptical shape, a semi-elliptical shape, or an elliptical dome-like shape. In some embodiments, at least a portion of the encasing includes a transparent material or a translucent material. The transparent material may include (but is not limited to) glass, plastic, crystal, or a combination thereof. The translucent material may include (but is not limited to) frosted glass, frosted plastic, frosted crystal, or a combination thereof. In some embodiments, the encasing shell 310 not only protects the fan blade LED assembly and prevents children from being injured by the fan blade but also enhances the visual effect of the images created by the fan blade LED assembly 300. In some embodiments, the encasing shell 310 may be filled with additional materials, such as glitters, to enhance the visual effect of the one or more images created by the fan blade LED assembly 300 further.

In some embodiments, the fan blade LED assembly 300 further includes an intercommunication module. The intercommunication module is configured to communicate with an external device, such as a mobile device or another smart toy. The fan blade LED assembly 300 is configured to display one or more images based on communication with the external device.

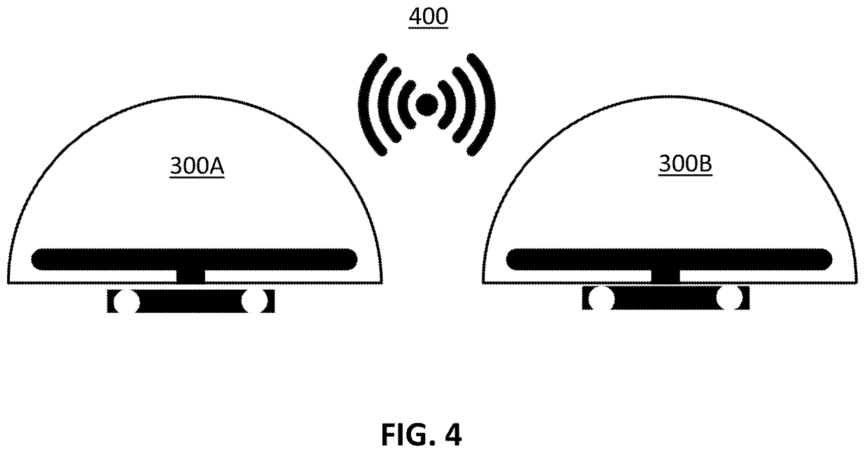

FIG. 4 illustrates an example environment 400, in which two fan blade LED assemblies 300A and 300B are configured to communicate with each other in accordance with one or more embodiments. Each of the fan blade LED assemblies 300A and 300B includes an intercommunication module configured to communicate wirelessly with each other or other devices. Responsive to communication between the two fan blade LED assemblies 300A and 300B, controllers of the two fan blade LED assemblies 300A and 300B are configured to synchronize and cause fan blade LED assemblies of the two fan blade LED assemblies 300A and 300B to display correlated images based on communication.

In some embodiments, the intercommunication module includes at least one of: a Wi-Fi module configured to communicate with external devices via a wireless internet network, a Bluetooth module configured to communicate with external devices over a short-range wireless network, a near field communication (NFC) module configured to communicate with external devices over a close-range wireless network, or a cellular radio module configured to communicate with external devices over a cellular network.

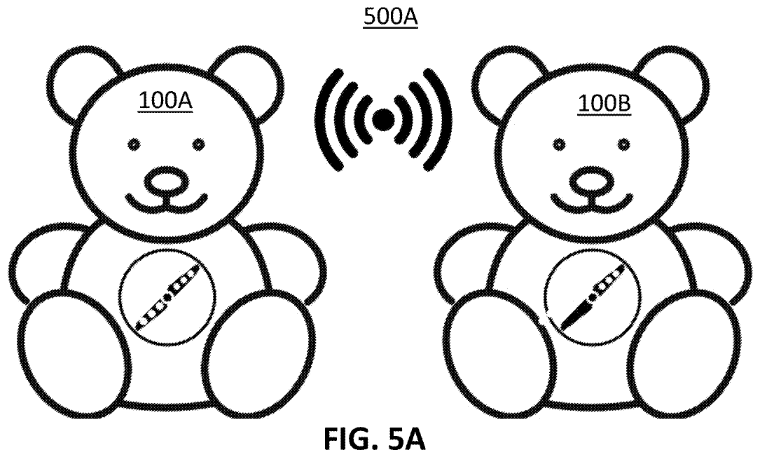

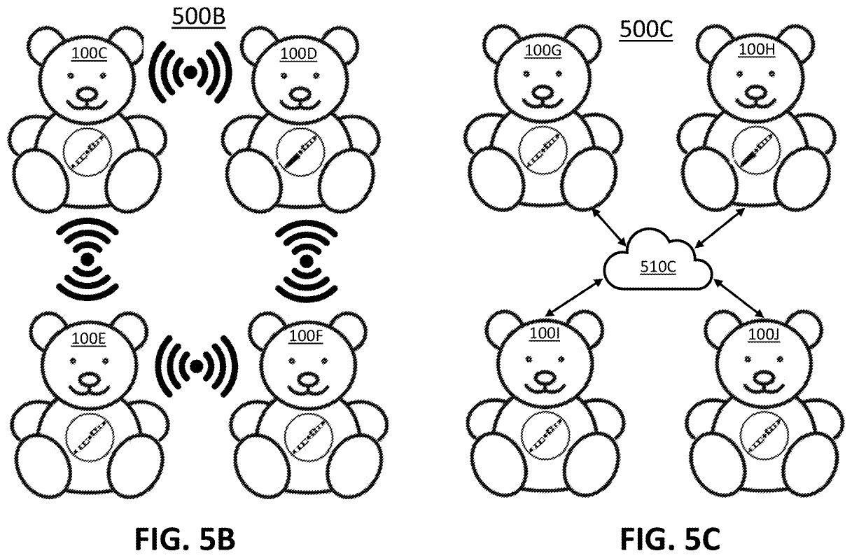

FIG. 5A illustrates an example environment 500A, in which two plush toys 100A and 100B are configured to communicate with each other. Controllers of the toys 100A and 100B are configured to synchronize to cause fan blade LED assemblies of the toy 100A and the toy 100B to display correlated images based on communication.

In some embodiments, the intercommunication module of a first toy 100A is configured to determine whether a second toy 100B is nearby or within a predetermined distance, and responsive to determining that the second toy 100B is nearby or within the predetermined distance, the controller of the first toy 100A causes its fan blade LED assembly to display one or more predetermined animations. Similarly, the controller of the second toy 100B does the same. Responsive to determining that the first toy 100A is nearby or within the predetermined distance, the controller of the second toy 100B causes its fan blade LED assembly to display one or more predetermined animations.

For example, a user of a toy may be able to associate a name with the toy. The intercommunication module of the toy may be configured to transmit the name associated with the toy to a nearby toy. When a first toy associated with a first name is near a second toy with a second name, the first toy may generate an image, greeting the second toy by the second name, and the second toy may generate an image, greeting the first toy by the first name. As another example, when the first toy and the second toy detect each other's presents, they may display a hand-waving animation or smiley face to each other.

In some embodiments, more than two toys are configured to communicate with each other simultaneously. FIG. 5B illustrates an example environment in which multiple toys 100C-100F are configured to communicate with each other via peer-to-peer communication in accordance with one or more embodiments. As illustrated, toy 100C is configured to communicate with toys 100D and 100E via peer-to-peer communication; toy 100D is configured to communicate with toys 100C and 100F via peer-to-peer communication; and so on and so forth. Controller of toys 100C through 100F may be configured to synchronize and cause fan blade LED assemblies of toys 100C through 100F to display correlated images based on the communication.

FIG. 5C illustrates an example environment 500C in which multiple toys 100G-100J are configured to communicate with each other via a network 510C in accordance with one or more embodiments. In some embodiments, the network 510C may be created using a pre-existing infrastructure, such as a Wi-Fi network established by a router. In some embodiments, each of the toys 100G-100J can connect to an access point to join the network 510C. In some embodiments, the network 510C is an ad hoc network that does not depend on pre-existing infrastructure, such as routers or access points. Such an ad hoc network can be formed via Wi-Fi or Bluetooth. Controller of toys 100G through 100J may be configured to synchronize and cause fan blade LED assemblies of toys 100G through 100J to display correlated images based on the communication.

### ADDITIONAL CONSIDERATIONS

The foregoing description of the embodiments has been presented for the purpose of illustration; many modifications and variations are possible while remaining within the principles and teachings of the above description.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C being true (or present). As a non-limiting example, the condition “A, B, or C” is satisfied when A and B are true (or present) and C is false (or not present). Similarly, as another non-limiting example, the condition “A, B, or C” is satisfied when A is true (or present) and B and C are false (or not present).

What is claimed is:

1. A toy comprising:
a plush body;
a fan blade LED assembly embedded in the plush body, the fan blade LED assembly comprising:
one or more fan blades;
an array of programmable LED lights on each of the one or more fan blades;
a motor coupled to the one or more fan blades to cause the one or more fan blades to rotate; and
a controller configured to control the motor and the array of programmable LED lights to cause the array of programmable LED lights to switch on or off in specific sequences while the one or more fan blades are rotating, creating one or more images; and
an encasing shell configured to encase the fan blade LED assembly, at least a portion of the encasing shell comprising a transparent material or a translucent material, through which the one or more images are projected.

2. The toy of claim 1, wherein the fan blade LED assembly further comprises an intercommunication module embedded in the plush body, the intercommunication module configured to communicate with an external device.

3. The toy of claim 2, wherein the controller is coupled to the intercommunication module and configured to:
process data received from the external device; and
cause the fan blade LED assembly to display one or more images based on the processing of the data received from the external device.

4. The toy of claim 3, wherein:
the toy is a first toy, and the external device is a second toy,
the first toy and the second toy are configured to communicate with each other, and
controllers of the first toy and the second toy are configured to synchronize and cause fan blade LED assemblies of the first toy and the second toy to display correlated images based on communication between the first toy and the second toy.

5. The toy of claim 3, wherein:
the toy is a first toy, and the first toy and a plurality of second toys are configured to form an ad hoc network, and
the ad hoc network facilitates communication among the first toy and the plurality of second toys, causing controllers of the first toy and the plurality of second toys to synchronize and cause fan blade LED assemblies of the first toy and the plurality of second toys to display one or more correlated images based on the communication.

6. The toy of claim 2, wherein the intercommunication module is configured to determine whether a second toy is nearby or within a predetermined distance, and responsive to determining that the second toy is nearby or within the predetermined distance, the controller causes the fan blade LED assembly to display one or more predetermined animations.

7. The toy of claim 2, wherein the intercommunication module includes at least one of: a Wi-Fi module configured to communicate with external devices via a wireless internet network, a Bluetooth module configured to communicate with external devices over a short-range wireless network, a near field communication (NFC) module configured to communicate with external devices over a close-range wireless network, or a cellular radio module configured to communicate with external devices over a cellular network.

8. The toy of claim 1, wherein the translucent material comprises at least one of: frosted glass, frosted plastic, or frosted crystal.

9. The toy of claim 1, wherein the encasing shell is in one of: a spherical shape, a semi-spherical shape, a dome-like shape, an elliptical shape, a semi-elliptical shape, or an elliptical dome-like shape.

10. The toy of claim 1, wherein the one or more images are configured to form one or more animations.
